(19) United States
(12) Patent Application Publication
(10) Pub. No.: US 2012/0320953 A1
(43) Pub. Date: Dec. 20, 2012

(54) Increasing Computational Efficiency in Digital/Analog Radios

(75) Inventors: Trudy D. Stetzler, Houston, TX (US); John Elliott Whitecar, Plymouth, MI (US)

(73) Assignee: TEXAS INSTRUMENTS INCORPORATED, Dallas, TX (US)

(21) Appl. No.: 13/159,704

(22) Filed: Jun. 14, 2011

(51) Int. Cl. H04L 27/00

(52) U.S. Cl. 375/216

(57) ABSTRACT

An embodiment of the invention provides a method for increasing computational efficiency in a system that can receive an analog radio signal and a digital radio signal concurrently. One tuner is tuned to an analog frequency and the source of the output of the radio during this time is analog. When a digital radio signal is detected, acquired and the quality of the digital radio signal is above an upper threshold, a digital data path is activated and the analog data path is inactivated. At this time, the source of the output of the radio is digital. The quality of the digital radio signal continues to be monitored. When the quality of the digital radio signal falls below a lower threshold, the analog data path is activated and the digital data path is inactivated. During this time, the source of the output of the radio is analog.

### BACKGROUND

With the advent of digital radio and the need to co-exist and switch between traditional analog and digital broadcasts, new requirements are being demanded of traditional radios. Current implementations of the US (United States) HD (Hybrid Digital) radio standard require that the AM (Amplitude Modulation)/FM (Frequency Modulation) analog processing be performed in parallel with the complete HD radio processing. In Europe, there is a desire to able to switch from DAB (Digital Audio Broadcast) digital broadcast to the same program on either another DAB station or on an analog FM broadcast in case of signal loss.

HD radio, which originally stood for “Hybrid Digital”, is the trademark for iBiquity's in-band on-channel (IBOC) digital radio technology used by AM and FM radio stations to transmit audio and data via a digital signal in conjunction with their analog signals. HD radio was selected by the United States Federal Communications Commission (FCC) in 2002 as a digital audio broadcasting method for the United States.

HD radio is currently used by some AM and FM radio stations to simulcast both digital and analog audio within the same channel (a hybridized digital-analog signal) as well as to add new FM channels and text information. As of May 2009, there were more stations in the world on the air with HD radio technology than any other digital radio technology

Digital Audio Broadcasting (DAB), is a digital radio technology for broadcasting radio stations, used in several countries, particularly in Europe. Traditionally radio programs were broadcast on different frequencies via FM and AM, and a radio had to be tuned into each frequency. This used up a comparatively large amount of spectrum for a relatively small number of stations (low spectrum efficiency).

Spectral efficiency, spectrum efficiency or bandwidth efficiency refers to the information rate that can be transmitted over a given spectral bandwidth (bandwidth is the difference between the upper and lower frequencies in a contiguous set of frequencies) in a specific communication system. It is a measure of how efficiently a limited frequency spectrum is utilized by the physical layer protocol, and sometimes by the media access control (the channel access protocol).

DAB is a digital radio broadcasting system that through the application of multiplexing and compression combines multiple audio streams onto a relatively narrow spectral band centered on a single broadcast frequency called a DAB ensemble. DAB ensembles are groups of DAB broadcasters transmitting multiple digital radio channels on a single radio transmission. The digital audio feeds from each radio station are multiplexed into one digital transmission, to be decoded by a receiver. While each station can use a different bit-rate, and either monophonic or stereophonic (one or two channels of audio) broadcasts, all stations will have exactly the same coverage area. Each ensemble can only have a certain maximum total bit-rate, a sort of “bit budget” or a specific amount of bandwidth that participating broadcasters must work within. Increasing the number of stations on an ensemble may require lower quality audio while increasing audio quality may require removing audio channels.

DAB uses substantially higher bandwidth than broadcast analogue FM communication. This has led to an increase in the number of stations available to listeners, especially outside of major urban areas. DAB broadcasts a single station that is approximately 1500 kilohertz wide (1000 kilobits per second). In contrast FM HD radio shares its digital broadcast with the traditional 200 kilohertz-wide channels, mixing digital and analog signals into a 400 Khz spectrum.

RDS (Radio Data System) is another communications protocol standard for simultaneously broadcasting digital and analog information. RDS embeds small amounts of digital information into conventional FM radio broadcasts. The RDS system standardizes several types of information transmitted, including time, station identification and program information. In addition, the RDS information includes alternate frequencies at which the identical program can be received in certain markets.

Concurrent radio broadcast of digital and analog signals may use a large amount of bandwidth and in a software defined receiver implementation also increases computational load on the digital signal processor. Reducing the amount of computational load used to concurrently decode broadcast digital and analog radio signals would allow more concurrent functions to operate on a given a given processor or allow less powerful processors to accomplish the required radio baseband decoding.

### BRIEF DESCRIPTION OF THE DRAWINGS

FIG. 1 is a block diagram of an embodiment of a two tuner, digital and analog radio architecture.

FIG. 2 is a block diagram of an embodiment of a two-tuner, HD and Diversity FM radio architecture.

FIG. 3 is a flow chart illustrating an embodiment of a method for increasing computational efficiency in a two-tuner, HD and Diversity FM radio architecture.

FIG. 4 is a block diagram of an embodiment of a single tuner, HD and FM radio architecture.

FIG. 5 is a flow chart illustrating an embodiment of a method for increasing computational efficiency in a single tuner, HD and FM radio architecture.

FIG. 6 is a block diagram of an embodiment of a two tuner, DAB and FM radio architecture.

FIG. 7 is a flow chart illustrating an embodiment of a method for increasing computational efficiency in a two tuner, DAB and FM radio architecture.

FIG. 8 is a flow chart illustrating an embodiment of a method for increasing computational efficiency in a digital and analog radio architecture with at least one tuner.

### DETAILED DESCRIPTION

The drawings and description, in general, disclose a method and system for increasing computational efficiency in radios that concurrently receive digital and analog radio signals. In one embodiment, at least one tuner is tuned to an analog frequency. After the at least one tuner is tuned to the analog frequency, an analog data path is activated. Next, the method determines whether a digital radio signal is present. When the digital radio signal is present, the digital radio signal is acquired. After the digital radio signal is acquired, a digital data path is activated when the quality of the digital radio signal is above a predetermined upper threshold. The analog data path is inactivated when the quality of the digital radio signal is above the predetermined upper threshold.

The quality of the digital radio signal is monitored to ensure that it remains above the predetermined upper threshold. When the quality of the digital radio signal falls below a predetermined lower threshold, the digital data path is inactivated and the analog data path is activated. Activating only a digital data path or only an analog data path increases the computational efficiency of the system. In addition, activating only a digital data path or only an analog data path reduces the amount of power used from what would have been used if both data paths were operating concurrently.

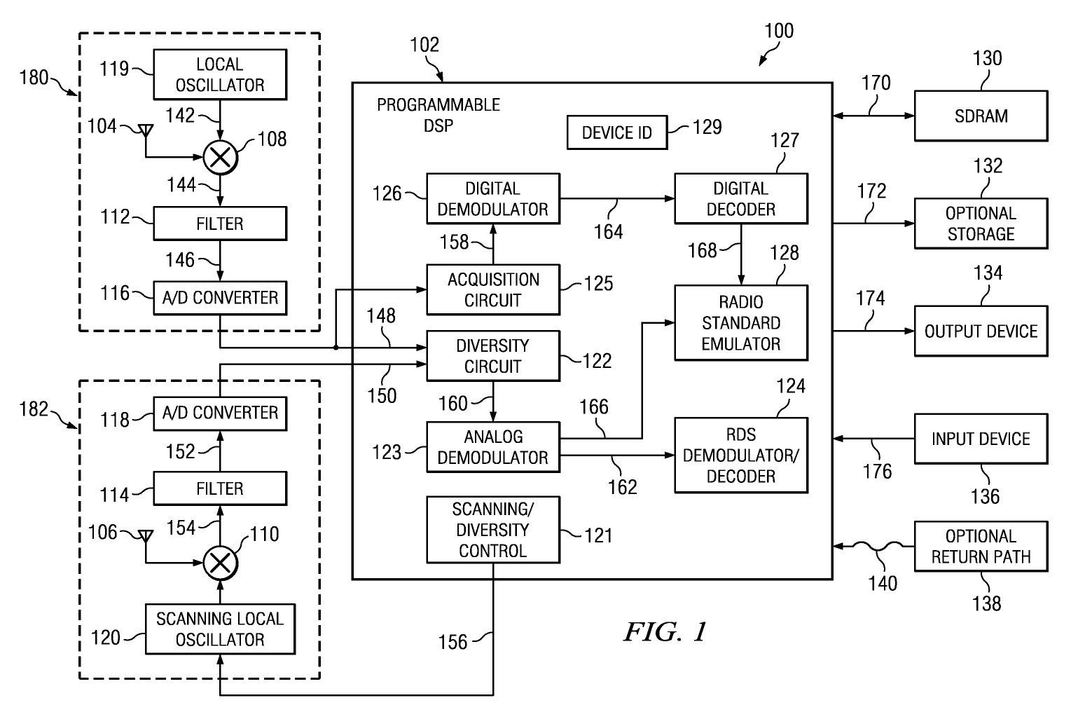

FIG. 1 is a block diagram of an embodiment of a two tuner, digital and analog radio architecture. FIG. 1 show two tuners, 180 and 182. Each tuner contains an antenna, 104 and 106, a local oscillator, 119 and 120, a down-converter, 108 and 110, a filter, 112 and 114, and an analog-to-digital converter (ADC), 116 and 118. The filters are used for anti-aliasing and image rejection. Channel selection may be done digitally, after the ADC.

FIG. 1 also shows a programmable DSP (digital signal processor) 102. In this example, the programmable DSP 102 is contained on a single integrated circuit. However, more than one integrated circuit may be used to contain a programmable DSP. In this example, a device ID (identification) 129 provides security, authorization etc. A digital data path in this example includes the acquisition circuit 125, the digital demodulator 126, and a digital decoder 127. The digital decoder 127 decodes the appropriate encoded formats (e.g. MPEG1, Layer 2, AAC, ACC-HF etc.). An analog data path in this example includes a diversity circuit 122, an analog demodulator 123 and an RDS demodulator/decoder 124. A scanning/diversity control circuit 121, in this example, may also be part of an analog path. The radio standard emulator 128 is used in both the analog data path and the digital data path.

External devices such as storage 130 and 132, input and output devices 134, 136, 138, may be used in conjunction with the programmable DSP 102. For example, SDRAM (synchronous dynamic random access memory) 130 may be used to store encoded digital audio. Other storage options 132 include compact flash memory, disk drives etc. Output devices 134 include speakers and LCDs (liquid crystal displays). Input devices 136 include voice, a keypad, a screen, a smart card, a compact flash card, a bluetooth link etc. An optional return path may include a cellular phone connected with the programmable DSP.

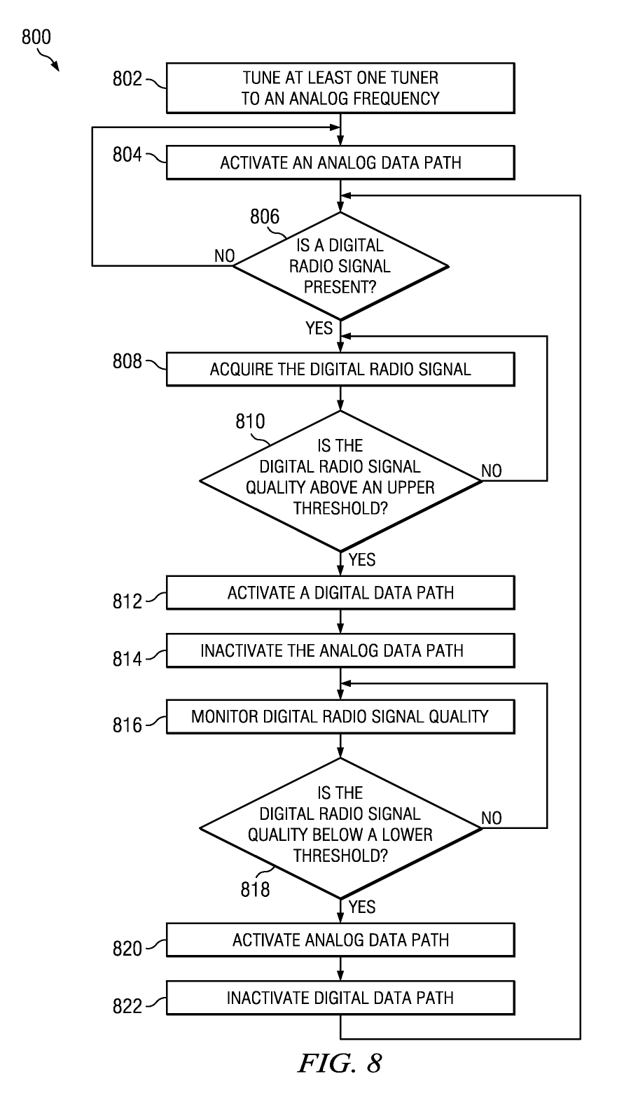

FIG. 8 is a flow chart illustrating an embodiment of a method for increasing computational efficiency in a digital and analog radio architecture with at least one tuner. In this embodiment, during step 802, a least one tuner is tuned to an analog frequency. During step 804, an analog data path is activated. The analog path, for example, may include a diversity circuit 122, an analog demodulator 123 and an RDS demodulator/decoder 124 as shown in FIG. 1. Next, during step 806, the method determines whether a digital radio signal is present. If the digital radio signal is not present, the analog data path remains active, allowing an analog FM or AM channel to be output to a speaker 134 for example. However, when a digital radio signal is present, the method acquires the digital radio signal as shown in step 808.

After the digital radio signal is acquired, it is determined whether the quality of the digital radio signal is above an upper threshold, step 810. The quality of the digital radio signal may be determined in several ways. For example, the BER (bit error rate) and errors reported from an audio codec (coder/decoder) may be used to determine upper and lower thresholds. In the case of HD broadcasts, a digital audio quality indicator is calculated in the HD decoder. This indicator has a range of 0-15 and may be used to also determine upper and lower thresholds. The digital signal quality level may also be measured using the ratio Cd/No where Cd is the power of the digital carrier and No is the noise level. These examples of how to measure the quality of a digital radio signal are not meant to be exhaustive and it is anticipated that other methods may be used.

When the quality of the digital radio signal is above the upper threshold, a digital data path is activated, step 812. In one embodiment, the digital data path includes acquisition circuit 125, digital demodulator 126 and digital decoder 127. During step 814 the analog data path is inactivated. The digital radio quality is monitored as shown in step 816. When the quality of the digital radio signal falls below a lower threshold, step 818, the analog data path is activated, step 820 and the digital data path is inactivated, step 822. After the digital data path is inactivated, the method returns to step 806 to determine whether a digital radio signal is present. When the digital radio signal quality does not fall below the lower threshold, the method returns to step 816 where the digital signal quality continues to be monitored.

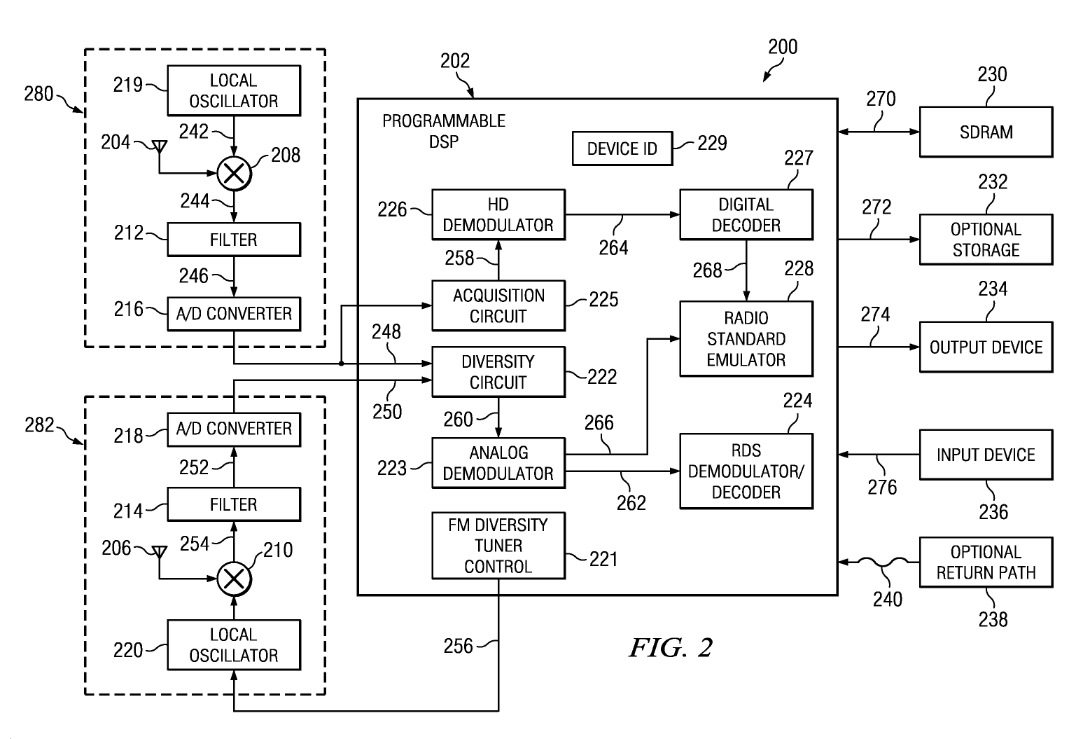

FIG. 2 is a block diagram of an embodiment of a two-tuner, HD and Diversity FM radio architecture. FIG. 2 show two tuners, 280 and 282. Each tuner contains an antenna, 204 and 206, a local oscillator, 219 and 220, a down-converter, 208 and 210, a filter, 212 and 214, and an analog-to-digital converter (ADC), 216 and 218. The filters are used for anti-aliasing and image rejection. In a wideband system, the channel selection may be done digitally, after the ADC.

The embodiment shown in FIG. 2 also shows a programmable DSP (digital signal processor) 202. In this example, the programmable DSP 202 is contained on a single integrated circuit. However, more than one integrated circuit may be used to contain a programmable DSP. In this example, a device ID (identification) 229 provides security, authorization etc. A digital data path in this example includes the acquisition circuit 225, the HD demodulator 226, and a digital decoder 227. The digital decoder 227 decodes the appropriate encoded formats (e.g. MPEG1, Layer 2, AAC, ACC-HF etc.). An analog data path in this example includes a diversity circuit 222, an analog demodulator 223 and an RDS demodulator/decoder 224. An FM diversity tuner control 221, in this embodiment, may also be part of an analog path. The radio standard emulator 228 is used in both the analog data path and the digital data path.

External devices such as storage 230 and 232, input and output devices 234, 236, 238, may be used in conjunction with the programmable DSP 202. For example, SDRAM (synchronous dynamic random access memory) 230 may be used to store encoded digital audio. Other storage options 232 include compact flash memory, disk drives etc. Output devices 234 include speakers and LCDs (liquid crystal displays). Input devices 236 include voice, a keypad, a screen, a smart card, a compact flash card, a bluetooth link etc. An optional return path may include a cellular phone connected with the programmable DSP 202.

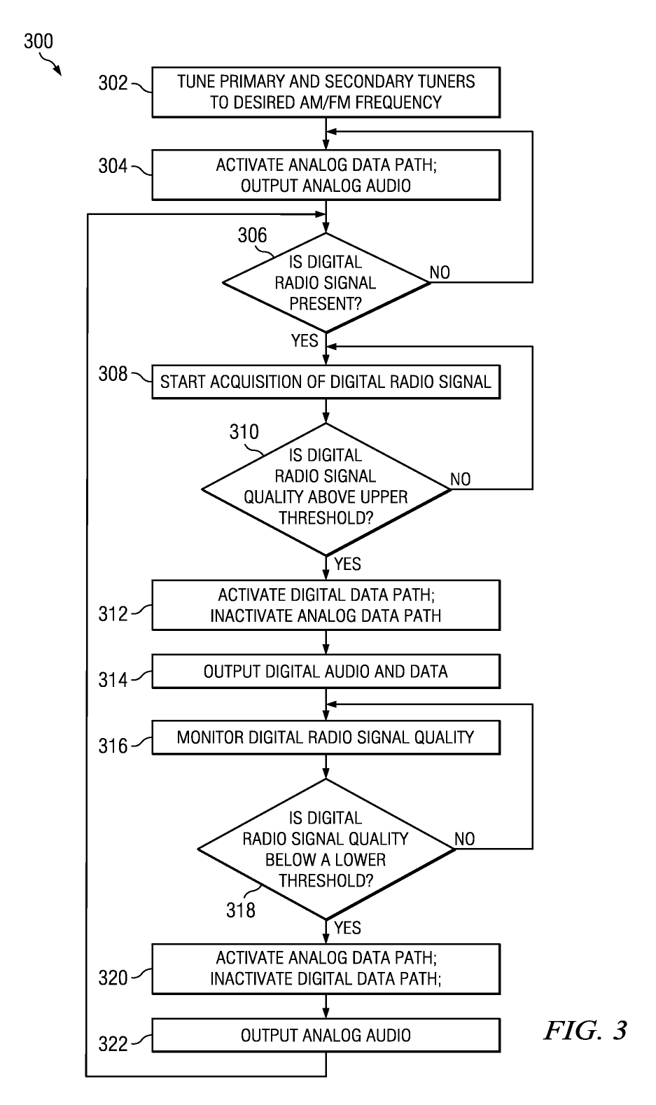

FIG. 3 is a flow chart illustrating an embodiment of a method for increasing computational efficiency in a two-tuner, HD and Diversity FM radio architecture. In this embodiment, during step 302, a primary 280 and a secondary 282 tuner are tuned to an AM or FM frequency. During step 304, an analog data path is activated and analog audio is output. The analog data path, for example, may include a diversity circuit 222, an analog demodulator 223 and an RDS demodulator/decoder 224 as shown in FIG. 2. The analog audio may be output to a speaker for example. Next, during step 306, the method determines whether a digital radio signal is present. If the digital radio signal is not present, the analog data path remains active, allowing an analog FM or AM channel to be output to a speaker 234 for example. However, when a digital radio signal is present, the method acquires the digital radio signal as shown in step 308.

After the digital radio signal is acquired, it is determined whether the quality of the digital radio signal is above an upper threshold, step 310. When the quality of the digital radio signal is above the upper threshold, a digital data path is activated, step 312. In one embodiment, the digital data path includes an acquisition circuit 225, an HD demodulator 226 and digital decoder 227. Also when the quality of the digital radio signal is above the upper threshold, an analog data path is inactivated. In this example, the analog data path includes FM diversity tuner control 221, diversity circuit 222 and RDS demodulator/decoder 224. When the quality of the digital radio signal is not above the upper threshold, the method returns to step 308.

During step 314 digital audio and data are output. For example, the digital audio may be output to a speaker and the digital data may be output to an LCD. The digital radio quality is monitored as shown in step 316. When the quality of the digital radio signal falls below a lower threshold, step 318, an analog data path is activated, step 320 and the digital data path is inactivated, step 820. In this example, the analog path includes the FM diversity tuner control 221, the diversity circuit 222, the analog demodulator 223, and the RDS demodulator/decoder 224. After the digital data path is inactivated, the method returns to step 320 to determine whether a digital radio signal is present.

When the digital radio signal quality does not fall below the lower threshold, the method returns to step 316 where the digital signal quality continues to be monitored.

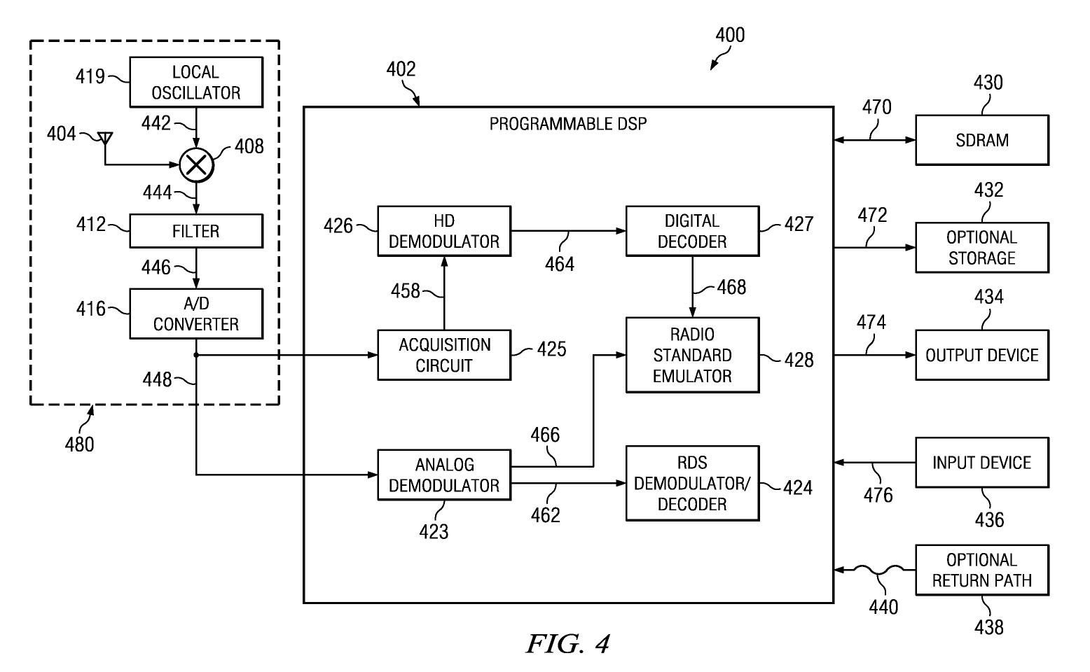

FIG. 4 is a block diagram of an embodiment of a single-tuner, HD and FM radio architecture. FIG. 4 shows a single tuner 480. The tuner 480 contains an antenna 404, a local oscillator 419, a down-converter 408, a filter 412, and an analog-to-digital converter (ADC) 416. The filter 412 is used for anti-aliasing and image rejection. Channel selection may be done digitally, after the ADC.

The embodiment shown in FIG. 4 also shows a programmable DSP 402. In this example, the programmable DSP 402 is contained on a single integrated circuit. However, more than one integrated circuit may be used to contain a programmable DSP. A digital data path in this example includes the acquisition circuit 425, the HD demodulator 426, and a digital decoder 427. The digital decoder 427 decodes the appropriate encoded formats (e.g. MPEG1, Layer 2, AAC, ACC-HF etc.). An analog data path in this example includes an analog demodulator 423 and an RDS demodulator/decoder 424. The radio standard emulator 428 is used in both the analog data path and the digital data path.

External devices such as storage 430 and 432, input and output devices 434, 436, 438, may be used in conjunction with the programmable DSP 402. For example, SDRAM (synchronous dynamic random access memory) 430 may be used to store encoded digital audio. Other storage options 432 include compact flash memory, disk drives etc. Output devices 434 include speakers and LCDs (liquid crystal displays). Input devices 436 include voice, a keypad, a screen, a smart card, a compact flash card, a bluetooth link etc. An optional return path may include a cellular phone connected with the programmable DSP 402.

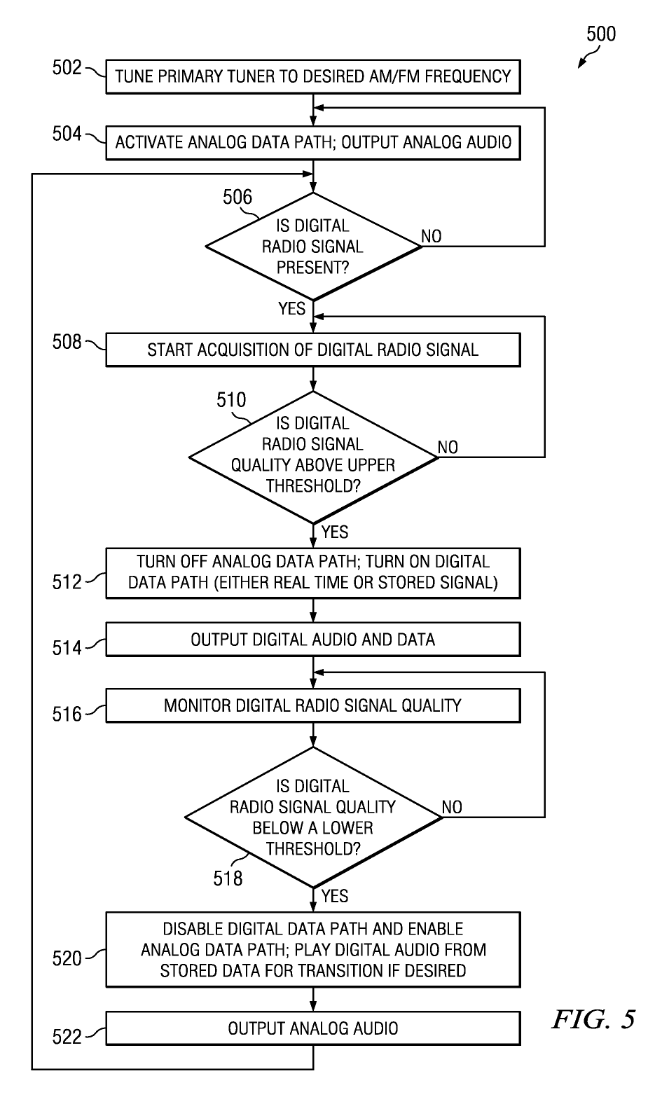

FIG. 5 is a flow chart illustrating an embodiment of a method for increasing computational efficiency in a single-tuner, HD, FM radio architecture. In this embodiment, during step 502, a primary 480 tuner is tuned to an AM or FM frequency. Next, during step 504, an analog data path is activated and analog audio is output to a speaker for example. During step 506, the method determines whether a digital radio signal is present. If the digital radio signal is not present, the tuner stays tuned to the AM or FM frequency and the analog data path remains active. However, when a digital radio signal is present, the method acquires the digital radio signal as shown in step 508.

After the digital radio signal is acquired 508, it is determined whether the quality of the digital radio signal is above an upper threshold, step 510. When the quality of the digital radio signal is above the upper threshold, a digital data path is activated, step 512. The digital data input to the digital data path may be real time data or stored data. In one embodiment, the digital data path includes an acquisition circuit 425, an HD demodulator 426 and digital decoder 427. Also when the quality of the digital radio signal is above the upper threshold, an analog data is inactivated. In this example, the analog data path includes analog demodulator 423 and RDS demodulator/decoder 424. When the quality of the digital radio signal is not above the upper threshold, the method returns to step 506.

During step 514 digital audio and data are output. For example, the digital audio may be output to a speaker and the digital data may be output to an LCD. The digital radio signal quality is monitored as shown in step 516. When the quality of the digital radio signal falls below a lower threshold, step 518, an analog data path is activated, step 520 and the digital data path is inactivated, step 520. Digital audio may be played from previously stored encoded data during transition from a digital data path to an analog data path. In this example, the analog path includes the analog demodulator 423, and the RDS demodulator/decoder 424. After the digital data path is inactivated, the method returns to step 506 to determine whether a digital radio signal is present.

During step 522, the analog data path enables audio and RDS outputs. When the digital radio signal quality does not fall below the lower threshold, the method returns to step 516 where the digital signal quality continues to be monitored.

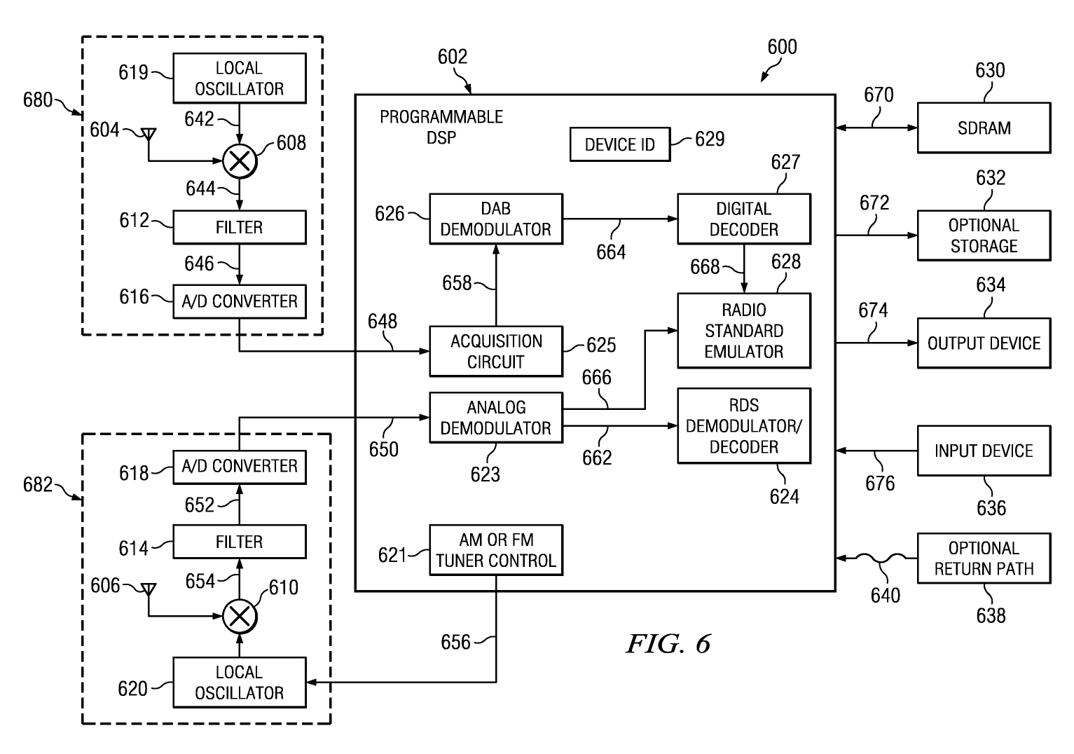

FIG. 6 is a block diagram of an embodiment of a two-tuner, DAB and FM radio architecture. FIG. 6 show two tuners, 680 and 682. Each tuner contains an antenna, 604 and 606, a local oscillator, 619 and 620, a down-converter, 608 and 610, a filter, 612 and 614, and an analog-to-digital converter (ADC), 616 and 618. The filters 616 and 618 are used for anti-aliasing and image rejection. Channel selection may be done digitally, after the ADC.

The embodiment shown in FIG. 6 also shows a programmable DSP 602. In this example, the programmable DSP 602 is contained on a single integrated circuit. However, more than one integrated circuit may be used to contain a programmable DSP. In this example, a device ID (identification) circuit 629 provides security, authorization etc. A digital data path in this example includes the acquisition circuit 625, the DAB demodulator 626, and a digital decoder 627. The digital decoder 627 decodes the appropriate encoded formats (e.g. MPEG1, Layer 2, AAC, ACC-HF etc.). An analog data path in this example includes an analog demodulator 623 and an RDS demodulator/decoder 624. The radio standard emulator 628 is used in both the analog data path and the digital data path.

External devices such as storage 630 and 632, input and output devices 634, 636, 638, may be used in conjunction with the programmable DSP 602. For example, SDRAM (synchronous dynamic random access memory) 630 may be used to store encoded digital audio. Other storage options 632 include compact flash memory, disk drives etc. Output devices 634 include speakers and LCDs (liquid crystal displays). Input devices 636 include voice, a keypad, a screen, a smart card, a compact flash card, a bluetooth link etc. An optional return path may include a cellular phone connected with the programmable DSP 602.

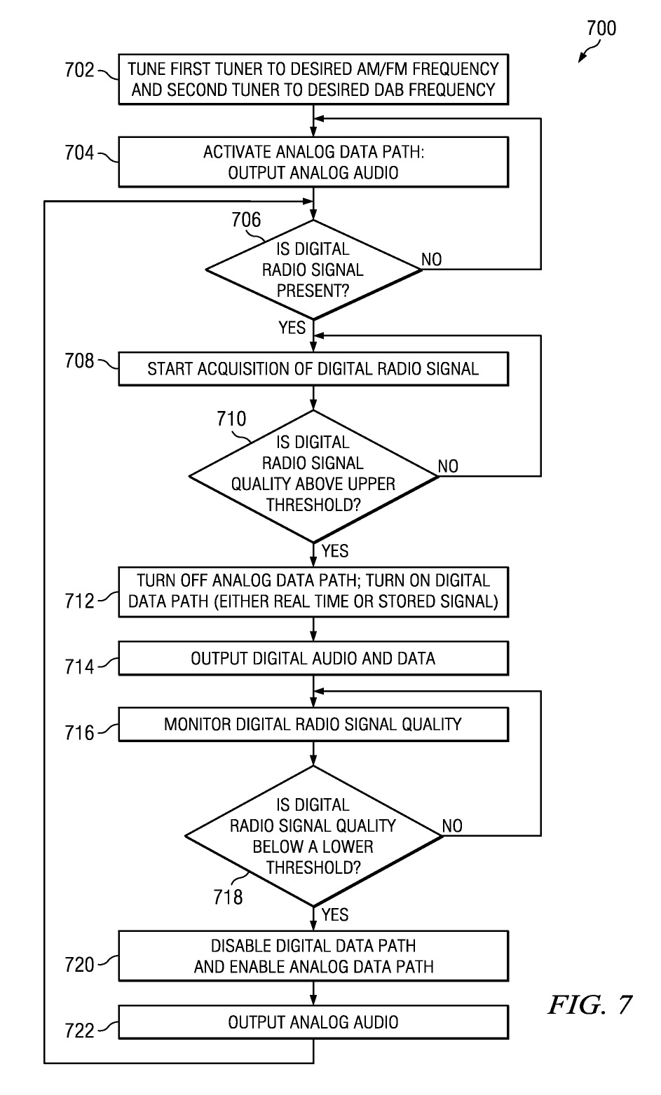

FIG. 7 is a flow chart illustrating an embodiment of a method for increasing computational efficiency in a two-tuner, DAB and FM radio architecture. In this embodiment, during step 702, a primary tuner 780 is tuned to an FM or AM frequency and a secondary 782 tuner is tuned to a DAB frequency. Next, during step 704, an analog data path is activated and analog audio is output. Next, during step 706, the method determines whether a digital radio signal is present. If the digital radio signal is not present the FM or AM frequency continues to be broadcast. However, when a digital radio signal is present, the method acquires the digital radio signal as shown in step 708.

After the digital radio signal is acquired, it is determined whether the quality of the digital radio signal is above an upper threshold, step 710. When the quality of the digital radio signal is above the upper threshold, a digital data path is activated, step 712. In one embodiment, the digital data path includes an acquisition circuit 625, a DAB demodulator 626 and digital decoder 627. The digital data may be real time digital data or stored digital data. Also when the quality of the digital radio signal is above the upper threshold, an analog data path is inactivated. In this example, the analog data path includes the analog demodulator 623 and RDS demodulator/decoder 624. When the quality of the digital radio signal is not above the upper threshold, the method returns to step 708.

During step 714 digital audio and data are output. For example, the digital audio may be output to a speaker and the digital data may be output to an LCD. The digital radio quality is monitored as shown in step 716. When the quality of the digital radio signal falls below a lower threshold, step 718, an analog data path is activated, step 720 and the digital data path is inactivated, step 720. Digital audio may be played from previously stored encoded data during transition from a digital data path to an analog data path. In this example, the analog path includes the analog demodulator 623, and the RDS demodulator/decoder 624. After the digital data path is inactivated, the method returns to step 706 to determine whether a digital radio signal is present.

During step 722, the analog data path enables audio and RDS outputs. When the digital radio signal quality does not fall below the lower threshold, the method returns to step 716 where the digital signal quality continues to be monitored.

The foregoing description has been presented for purposes of illustration and description. It is not intended to be exhaustive or to limit the invention to the precise form disclosed, and other modifications and variations may be possible in light of the above teachings. The embodiments were chosen and described in order to best explain the applicable principles and their practical application to thereby enable others skilled in the art to best utilize various embodiments and various modifications as are suited to the particular use contemplated. It is intended that the appended claims be construed to include other alternative embodiments except insofar as limited by the prior art.

What is claimed is:

1. A method of increasing computational efficiency in a system that can receive an analog radio signal and a digital radio signal concurrently comprising:
tuning at least one tuner to an analog frequency;
activating a first analog data path;
determining whether the digital radio signal is present;
acquiring the digital radio signal when the digital radio signal is present ;
activating a digital data path and inactivating a second analog data path when the quality of the digital radio signal is above an upper threshold;
activating the second analog data path and inactivating the digital data path when the quality of the digital radio signal is below a lower threshold.

2. The method of claim 1 wherein tuning at least one tuner comprises tuning a primary tuner and a secondary tuner to the analog frequency.

3. The method of claim 2 wherein activating the first analog data path comprises:
activating an FM diversity circuit, an analog demodulator circuit and a radio data system (RDS) demodulator/decoder circuit.

4. The method of claim 2 wherein determining whether the digital radio signal is present includes activating an acquisition circuit.

5. The method of claim 2 wherein activating the digital data path comprises activating an HD demodulator and a digital decoder.

6. The method of claim 2 wherein inactivating the second analog data path comprises inactivating a scanning FM diversity tuner control, a diversity circuit, and an RDS demodulator/decoder.

7. The method of claim 2 wherein activating the second analog data path comprises activating a scanning FM diversity tuner control circuit, a diversity circuit, and an RDS demodulator/decoder.

8. The method of claim 1 wherein the quality of the digital radio signal is determined by the bit error rate and errors reported from an audio codec.

9. The method of claim 1 wherein tuning at least one tuner comprises tuning one and only one tuner to the first analog frequency.

10. The method of claim 9 further comprising:
storing encoded digital data after acquiring the digital radio signal.

11. The method of claim 10 wherein activating the digital data path comprises activating an HD demodulator and a digital decoder.

12. The method of claim 11 wherein the digital data path receives as input the stored encoded digital data.

13. The method of claim 11 wherein the digital data path receives as input real time encoded digital data.

14. The method of claim 1 wherein tuning at least one tuner comprises tuning a primary tuner to the analog frequency and tuning a secondary tuner to a DAB (digital audio broadcast) digital frequency.

15. A system for increasing computational efficiency of analog radio and digital radio signals that can be broadcast concurrently comprising:
at least one tuner;
a programmable digital signal processor (DSP), the DSP comprising:
an analog data path; and
a digital data path;
wherein the at least one tuner is tuned to a first analog frequency;
wherein the analog data path is activated;
wherein when the digital radio signal is present, the digital radio signal is acquired;
wherein the digital data path is activated and the analog data path is inactivated when the quality of the digital radio signal is above an upper threshold;
wherein the analog data path is activated and the digital data path is inactivated when the quality of the digital radio signal is below a lower threshold.

16. The system of claim 15 wherein the at least one tuner comprises:
an antenna;
a local oscillator;
a down converter;
a filter; and
an analog-to-digital converter.

17. The system of claim 15 wherein the system further comprises;
storage;
an output device;
an input device; and
optional return path.

18. The system of claim 17 wherein storage is selected from a group consisting of a SDRAM, a compact flash drive, and a disk drive.

19. The system of claim 17 wherein the input device is selected from a group consisting of a voice, a keypad, a screen, a smart card, a compact flash card, and a Bluetooth link.

20. The system of claim 15 wherein the DSP is physically located on a single integrated circuit.
